(19) United States
(12) Patent Application Publication
(10) Pub. No.: US 2021/0350045 A1
(43) Pub. Date: Nov. 11, 2021

(54) STOCHASTIC BAG GENERATOR

(71) Applicants: Amit Ashok, Tucson, AZ (US); James Liang Chih Huang, Gainesville, FL (US)

(72) Inventors: Amit Ashok, Tucson, AZ (US); James Liang Chih Huang, Gainesville, FL (US)

(73) Assignee: Arizona Board of Regents on behalf of the University of Arizona, Tucson, AZ (US)

(21) Appl. No.: 17/286,425

(22) PCT Filed: Oct. 15, 2019
(86) PCT No.: PCT/US2019/056366

§ 371 Date: Apr. 16, 2021

Related U.S. Application Data
(60) Provisional application No. 62/746,466, filed on Oct. 16, 2018.

(51) Int. Cl. G06F 30/20; G01V 5/00; G01N 23/20008; G01N 23/207; G06K 9/62; G06N 7/00

(52) U.S. Cl. CPC G06F 30/20; G01V 5/005; G01N 23/20008; G06F 2111/08; G06K 9/6226; G06N 7/005; G01N 23/2076

(57) ABSTRACT

Apparatus and methods are disclosed for providing virtual bags that can be used to simulate and quantify performance of different explosive detection system architectures. The virtual bags can be provided to a simulator for designing and simulating operation of imaging scanners, including X-ray and millimeter-wave based threat detection equipment deployed in transit facilities and other secure locations. One example method of generating container models for a container inspection system includes generating a plurality of objects using a probability function; generating a respective position, scale, and orientation for each of the objects within a container having a defined boundary; generating pairings for a respective material for each of the objects using a probability function; and storing a container instance indicating at least one of: the generated pairings, the respective object positions, object scales, object orientation, the objects, or the respective materials in a computer-readable storage device.

### CROSS-REFERENCE TO RELATED APPLICATIONS

This application claims the benefit of and priority to U.S. Provisional Patent Application No. 62/746,466, entitled “STOCHASTIC BAG GENERATOR,” filed Oct. 16, 2018, which application is incorporated herein by reference in its entirety.

### ACKNOWLEDGMENT OF GOVERNMENT SUPPORT

This invention was made with government support under Grant No. HSHQDC-14-C-B0010 awarded by the Department of Homeland Security, Science and Technology Directorate, Explosives Division, BAA13-05. The government has certain rights in the invention.

### BACKGROUND

Threat detection at checkpoints for commercial and defense installations, such as airports and military bases, plays a critical role in securing facilities and people. Imaging scanners, including, X-ray and millimeter-wave based threat detection equipment are now widely deployed in transit facilities, e.g. airports and train stations, along with other threat detection modalities, such as metal detectors, millimeter wave backscatter imaging and ion-based explosive detectors. Current X-ray threat detection systems typically employ two or more views or projections to generate dual energy photoabsorption measurements that can provide material density and effective atomic number estimates for material discrimination. However, such systems are being constantly challenged by evolving nature of threats. Thus, there is ample opportunity for improvement to design and testing of such scanning imagers.

### SUMMARY

Apparatus and methods are disclosed herein for providing a stochastic bag generator (SBG), which provides virtual bags that can be used to simulate and quantify performance of different EDS system architectures. In some examples of the disclosed technology, a stochastic bag generator can be used to generate a large ensemble, for example 100,000 or more test bags or containers to provide to a virtual X-ray system simulation environment. By providing a large data set of test containers, a large set of statistics can be generated used to analyze and design existing and future X-ray based threat detection systems (e.g., Advanced Technology (AT), Explosive Detection Systems, and X-ray diffraction (XRD) systems). Disclosed examples of stochastic bag generators can be used to generate individualized virtual baggage that can be tailored to model classes of specific threats and concealments, for example thin-sheet threats, shielded objects, concealed objects, or other such threats.

In some examples, a three-dimensional mesh-shaped library is used. The data generated representing the containers can be provided to an X-ray simulation tool, including those using stochastic techniques or deterministic methods.

In some examples of the disclosed technology, a system of one or more computers can be configured to perform particular operations or actions by virtue of having software, firmware, hardware, or a combination of them installed on the system that in operation causes or cause the system to perform the actions. One or more computers can be configured to execute computer-readable instructions that cause the computer to perform particular operations or actions. According to one general aspect of the disclosed technology, a computer-implemented method of generating container models for a container inspection system includes generating a plurality of objects using a probability function and storing a container instance indicating the generated objects in a computer-readable storage medium, device, or memory. In some examples, the generating objects includes selecting objects using the probability function. For example, an object can be selected from a library or database comprising a plurality of objects using the probability function. In some examples, the generating objects can include generating a respective position, scale, and orientation for each of the objects within a container having a defined boundary using a probability function. For example, at least one of the respective position, scale, and orientation for the respective object can be selected using a probability function. In some examples, the generating objects can include generating pairings for a respective material for each of the objects using a probability function. and storing a container instance indicating at least one of: the generated pairings, the respective object positions, object scales, object orientation, the objects, or the respective materials in a computer-readable storage device. Other examples of this aspect include corresponding computer systems, apparatus, and computer programs recorded on one or more computer storage devices, each configured to perform the actions of the methods. In some examples, reconfigurable logic such as at least one field programmable gate array (FPGAs) is programmed to perform at least a portion of disclosed actions.

Some implementations of the disclosed technology can include one or more of the following features. The method further including: simulating operation of a scanning imager with the stored container instance. The method, where at least one of the probability functions is a probability mass function. The method further including: modeling physical deformation of at least one of the objects within the container. The method further including: selecting at least one of the objects to have a category of threat or weapon. The method where: the generating a respective position includes using a probability mass function representing two or more layers or regions within the container. The method where: the probability mass function includes a conditional probability for each level of a hierarchy of categories for the object. The method where: the probability mass function includes a value representing a probability that an object has a particular shape. The method where: the probability mass function includes a value representing a probability that the respective object includes a particular category of material. The method where: at least one of the plurality of objects has dimensions defined by scaling a parameterized version of the at least one object. The method where: a probability associated with the position of at least one of the objects is at least partially dependent on the position of another one of the objects. In some examples, computer-readable storage media store computer-executable instructions that when executed, caused the computer to perform any one or more disclosed methods.

In some of examples of the disclosed technology, the method of generating the objects comprises at least one of the following actions: (A) selecting the objects; (B) generating a respective position, scale, and orientation for each of the objects within a container having a defined boundary; and/or (C) generating pairings for at least one respective material for each of the objects; where at least one of the actions (A), (B), or (C) is performed using a probability function. In some examples, actions (A) and (B) are performed using a probability function. In some examples, actions (B) and (C) are performed using a probability function. In some examples actions (A), (B), and (C) are performed using a probability function. In some examples, one or more of the actions (A), (B), or (C) are performed using a probability function, and one or more other actions of (A), (B), or (C) are performed using another function, for example, using a deterministic function, a table lookup, or based on input from an external function. In some examples, at least one, and in some cases all, of the probability functions are probability mass functions. In some examples, each of actions (A), (B), and/or (C) is performed using a different probability functions, while in other examples, at least one of (A), (B), and/or (C) is performed using the same probability function.

One general aspect includes the method where: the generating a respective position includes selecting an orientation for each of the objects, at least one of the objects having an orientation constraint. One general aspect includes the method where: the probability mass function includes a value representing a probability that an object is in a selected category of a plurality of categories. One general aspect includes the method of claim any one where the plurality of categories includes at least one of: basics, clothing, documents, electronics, health, threats, toiletries, or weapons. Other examples of this aspect include corresponding computer systems, apparatus, and computer programs recorded on one or more computer storage devices, each configured to perform the actions of the methods.

One general aspect includes the method of any one where: at least one of the objects is a composite object including two or more shapes and/or two or more materials. Other examples of this aspect include corresponding computer systems, apparatus, and computer programs recorded on one or more computer storage devices, each configured to perform the actions of the methods. In some examples, reconfigurable logic such as field programmable gate arrays (FPGAs) are programmed to perform at least a portion of disclosed actions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of an example system in which certain disclosed apparatus and methods can be implemented.

FIG. 2 is a diagram outlining example objects, materials, and operations that can be performed in certain examples of the disclosed technology to produce container instances.

FIG. 3 is a diagram outlining an example of using probability bass functions to enable object selection and object/material pairing, as can be performed in certain examples of the disclosed technology.

FIG. 4 is a diagram outlining an example of applying constraints to place objects within a container instance, as can be performed in certain examples of the disclosed technology.

FIG. 5 is a diagram depicting different amounts of layering on a resulting container instance in a particular example.

FIG. 6 is an illustration depicting an example of an object database, in a particular example of the disclosed technology.

FIG. 7 is a chart showing attenuation of X-ray radiation for different liquid materials in a particular example of the disclosed technology.

FIG. 8 is a chart showing attenuation of X-ray radiation for different solid materials in a particular example of the disclosed technology.

FIG. 9 is a diagram illustrating an example of a scalable object in a particular example of the disclosed technology.

FIG. 10 is a diagram illustrating an example object that can be scaled to create instances within a container in a particular example of the disclosed technology.

FIG. 11 is a diagram illustrating an example object hierarchy in a particular example of the disclosed technology.

FIG. 12 depicts an example file including data for an unscaled probability mass function in a particular example of the disclosed technology.

FIG. 13 is a chart illustrating probability mass functions assigned to different items in an object database in a particular example of the disclosed technology.

FIG. 14 is a chart depicting an example layer configuration, as can be used in certain examples of the disclosed technology.

FIG. 15 depicts an example file storing data specifying layer regions for a container, as can be implemented in certain examples of the disclosed technology.

FIG. 16 is a diagram depicting use of rotation constraints within a container, as can be implemented in certain examples of the disclosed technology.

FIG. 17 is a flow chart outlining an example method of generating models for a container inspection system, as can be performed in certain examples of the disclosed technology.

FIG. 18 is a table indicating a number of function calls and total time spent executing procedures, as can be performed in certain examples of the disclosed technology.

FIG. 19 as a table indicating a number of function calls and total time spent in different procedures when generating the illustrated container instance in a particular example of the disclosed technology.

FIG. 20 is a diagram outlining minimum and maximum extent of an example object, as can be used in certain examples of the disclosed technology.

FIG. 21 is a flow chart outlining an example method of determining a bounding box for an object, as can be performed in certain examples of the disclosed technology.

FIG. 22 is a flow chart outlining an example method of configuring a bag container, as can be performed in certain examples of the disclosed technology.

FIG. 23 is a flow chart outlining an example method of packing objects into a configured container, as can be performed in certain examples of the disclosed technology.

FIG. 24 is a chart depicting probability mass functions for a number of items in an object database, as can be implemented in certain examples of the disclosed technology.

FIG. 25 is a chart depicting probability mass functions for items in the database after an object has been selected to add to the container instance.

FIG. 26 is a flow chart outlining an example method of placing objects in a container, as can be performed in certain examples of the disclosed technology.

FIG. 27 is a flow chart outlining an example method of selecting materials for an object, as can be performed in certain examples of the disclosed technology.

FIG. 28 is an example of a JSON data file storing a portion of objects and a container instance in a particular example of the disclosed technology.

FIG. 29 illustrates an example container instance having a number of different objects within the container region, as can be generated using example methods disclosed herein.

FIG. 30 is a flow chart outlining an example method of generating container models for a container inspection system, as can be performed in certain examples of the disclosed technology.

FIG. 31 illustrates a generalized example of a suitable computing environment in which described embodiments, techniques, and technologies can be implemented.

### DETAILED DESCRIPTION

### I. General Considerations

Examples of methods, apparatus, and systems for generating models for testing and simulating scanning imagers, including X-ray, computer tomography, magnetic resonance, and millimeter wave imagers are disclosed. The disclosed methods, apparatus, and systems should not be construed as being limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other things and methods. Additionally, the description sometimes uses terms like “produce,” “generate,” “propagate,” “receive,” “emit,” and “provide” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Moreover, unless the context dictates otherwise, the term “coupled” means mechanically, electrically, or electromagnetically connected or linked and includes both direct connections or direct links and indirect connections or indirect links through one or more intermediate elements not affecting the intended operation of the described system.

Additionally, certain terms may be used such as “up,” “down,” “upper,” “lower,” and the like. These terms are used, where applicable, to provide some clarity of description when dealing with relative relationships. But, these terms are not intended to imply absolute relationships, positions, and/or orientations.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (including random-access memory, such as dynamic RAM (DRAM), static RAM (SRAM), or embedded DRAM (eDRAM), or non-random access memories, such as certain configurations of registers, buffers, or queues), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., implemented with general-purpose CPUs and/or specialized processors, such as graphics processing units (GPUs) or tensor processing units (TPUs); application-specific integrated circuits (ASICs), or programmable logic, such as field programmable gate arrays (FPGAs) executing on any suitable commercially-available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented with software written in C, C++, Java, MATLAB, or any other suitable programming language. Likewise, the disclosed technology is not limited to any particular computer or category of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technology

Testing and qualification of explosive detection systems (EDS) is typically implemented by scanning control bags, which is a costly, time-intensive process, which limits the number of bags that can be tested to a few thousand at most. Apparatus and methods are disclosed herein for providing a stochastic bag generator (SBG), which provides virtual bags that can be used to simulate and quantify performance of different EDS system architectures.

In some examples of the notes closed technology, a stochastic bag generator can be used to generate a large ensemble, for example 100,000 or more test bags or containers, to provide to a virtual X-ray system simulation environment. By providing a large data set of test containers, a large set of statistics can be generated used to analyze and design existing and future X-ray based threat detection systems (e.g., Advanced Technology (AT), Explosive Detection Systems, and X-ray diffraction (XRD) systems). Disclosed examples of stochastic bag generators can be used to generate individualized virtual baggage that can be tailored to model classes of specific threats and concealments, for example: thin-sheet threats, shielded objects, concealed objects, or other such threats.

In some examples, a three-dimensional mesh-shaped library is used. Such a mesh-shaped library can be constructed using X-ray and/or optical scans of typical items found in transportation streams such as jars, boxes, bottles, electronics, and other such objects. Various materials data sources, for example, the DHS 13-05 test material list, which includes about 145 different materials, can be used to describe the material composition of the items. The material data includes information about the material's photoelectric, Compton, and Rayleigh cross-section across range of X-ray energies, e.g., 20 keV to 200 keV, as well as density range. The material data can include non-benign materials such as TNT, gunpowder, gasoline, MEKP, ammonium nitrate as well as benign materials such as water, milk, perfume, deodorant, cotton, steel, aluminum, or other such materials. An example of a suitable tool for generating X-ray cross-sections for such materials is the NIST's XCOM tool, which is available at the following address: https://physics.nist.gov/PhysRefData/Xcom/html/xcom1.html.

Examples of suitable simulation tools include those using stochastic techniques (e.g., Monte Carlo simulation) as well as those using deterministic methods based on Beer's attenuation law or using a first-Born approximation. Container instances generated according to the disclosed techniques can be provided to such tools and simulated. In some examples, a two-stage simulation approach may be taken where stochastic techniques are used to sample objects and generate sparse scattering points, and then use the sparse scattering points in a deterministic analysis. Such X-ray simulation tools can be adapted to use container instances generated by the present disclosure. Although X-ray or millimeter wave simulators are typically used because those are the spectra employed by threat detection equipment in current use, as will be readily understood by a person of ordinary skill in the art having the benefit of the present disclosure, disclosed techniques can be used to generate container instances used by simulators configured to simulate other suitable electromagnetic spectra.

Some suitable simulation tools model photons as a set of rays emitted from point sources toward an array of detector pixels. Intensity of the rays is reduced as it penetrates objects in a simulated bag. The number of transmitted photons is calculated to be inversely proportional to the path length based on an attenuation coefficient that models thickness and properties of material traversed by the simulated rays. In some examples, Compton or Rayleigh effects can also be modeled in the simulation tool. Further details of suitable X-ray simulation tools that can be used with certain examples of the disclosed technology include those discussed in Gong et al., “Rapid Simulation of X-ray Transmission Imaging for Baggage Inspection via GPU-Based Ray-Tracing,” 415 Nuclear Inst. and Methods in Physics Research B 100-109 (2018); and Gong et al., “Rapid Simulation of X-ray Scatter Measurements for Threat Detection via GPU-Based Ray-Tracing,” 415 Nuclear Instruments and Methods in Physics Research Section B: Beam Interactions with Materials and Atoms, 86-93 (2019).

### III. Example Stochastic Bag Generator

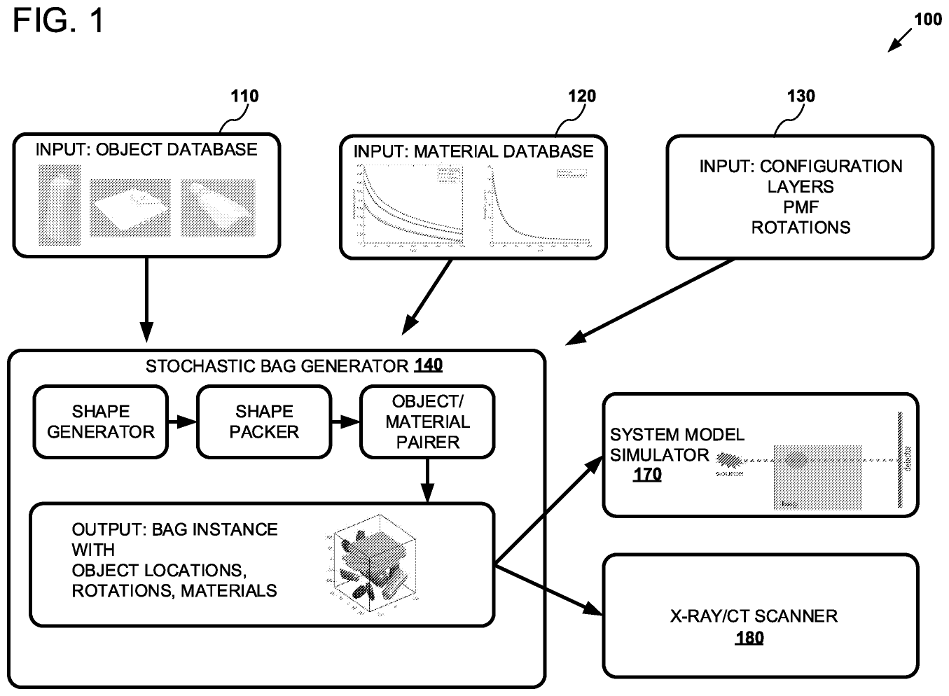

FIG. 1 is a diagram 100 of an example system in which certain disclosed apparatus and methods can be implemented. As shown, data describing objects and materials to be placed within a container are provided. In the illustrated example, objects 110 and materials 120 were provided in separate databases although in other examples, they can be provided as a single database, in a file, provided as data over a network, provided as a data service, or provided in any other suitable manner. An additional database 130 providing additional data describing item configuration, item layer rules, probability functions such as probability mass functions, item rotation, orientation, or other suitable information can be used to generate container instances as described in further detail below.

The input data is provided to a stochastic bag generator 140. The generator can be implemented by providing computer instructions that are executed by one or more processors (e.g., CPUs, GPUs, TPUs, and/or ASICs) and/or programmable logic (e.g., FPGAs) in a computing environment. The generator 140 can perform a number of different operations including a shape generator, a shape packer, and an object/material pairer. Further details on these operations are provided below. In general, a number of objects of different categories, per predetermined probabilities, are selected and placed at different positions and orientations within the target container instance. A hierarchy of probabilities for different object categories and subcategories is traversed in order to perform object and material pairing. For example, clothing items are more likely to be fabricated from textiles while containers are likely to be constructed from glass, metal, plastic, or other such materials. Once the objects are placed within the container, the generator 140 outputs a container instance that has the placed object locations, size (scale) rotations, and materials. The output container instance can be provided to a system modeling simulator. Such systems can model the effect of one or more electromagnetic radiation sources applied to the container, for example X-ray or millimeter wave radiation sources. The system modeling simulator can further model scattering and absorption of the emitted radiation according to the objects and materials described in the container instance. In some examples, information determined from running a number of different container instance models through the system modeling simulator 170 can be provided to adjust operation of a physical X-ray or CT scanner 180. For example, imaging software, radiation source locations, detector locations, or image processing algorithms can be adjusted based on learnings from modeling the container instances in the system modeling simulator.

Hence, the disclosed techniques can be used to model a large number of containers having realistic contents and position of such contents within a container, without having to rely on data generated from real-world examples, which does not scale effectively. Further, using data from real-world examples can raise privacy and regulatory concerns, and therefore, challenging to employ in an iterative approach where parameters of an explosive detection system being designed can be adjusted based on learnings from simulation of such a system model.

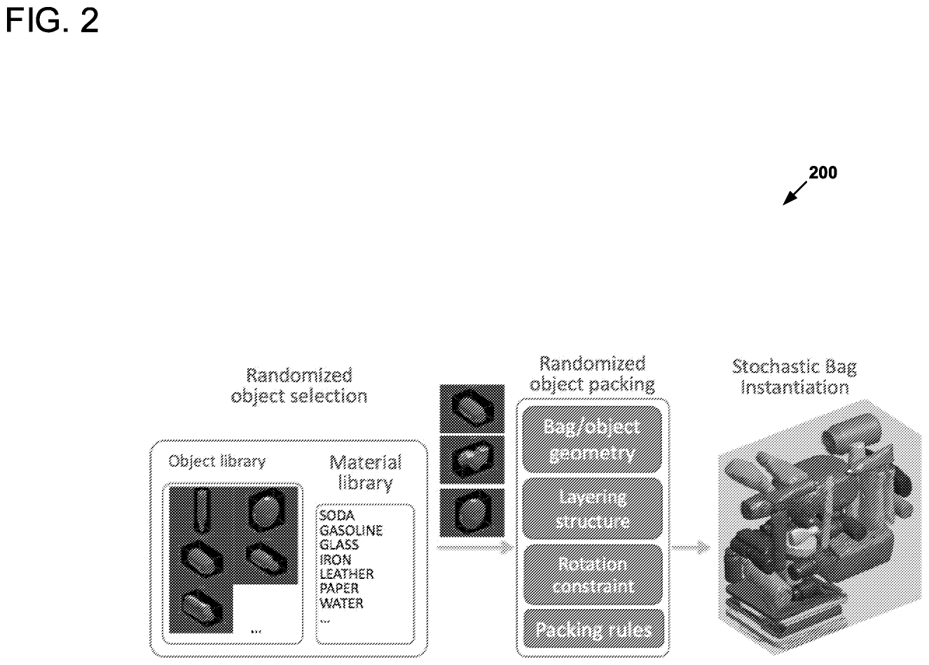

FIG. 2 is a diagram 200 outlining example objects, materials, and operations that can be performed to produce a container instance that can be used to simulate operation of a scanning imager, as can be implemented in certain examples of the disclosed technology. Pseudo-randomized object selection, per predetermined probability rules, can be used to select objects having different shapes from an object library that can be paired with materials selected from a material library. In some examples, the objects are complex, being formed from two or more different shapes and/or materials. Selected objects are then packed in a particular container instance. Parameters that can be adjusted or selected include geometry of the container (bag) or objects in the container, layering structure within the container, rotation scale/size and other position constraints, and object packing rules. Multi-material complex objects, such as electronics can be modeled as composite or complex objects. The layering structure can model distinct layouts that are found in different categories of containers, for example different categories of suitcases or air cargo pallets.

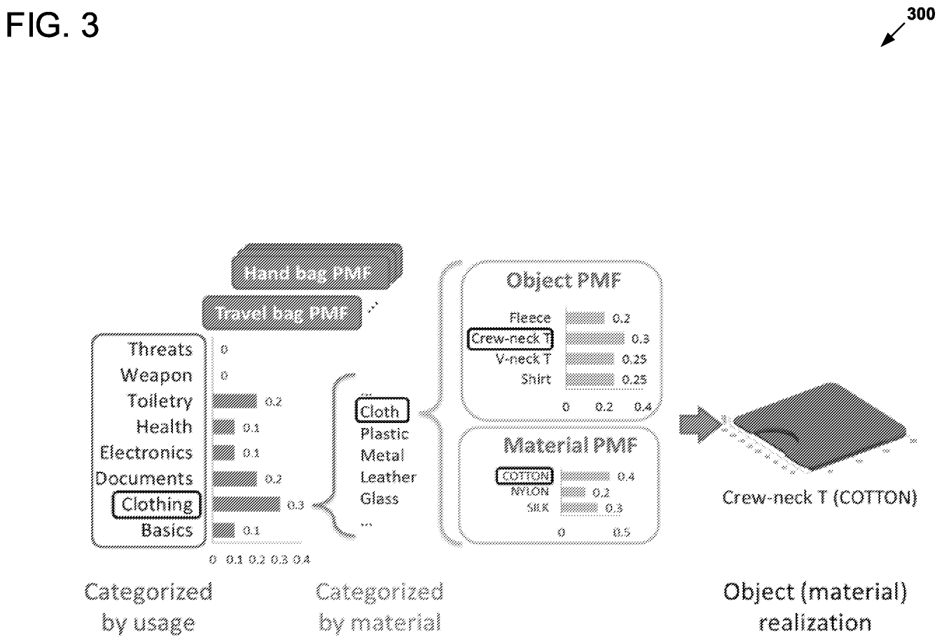

FIG. 3 is a diagram 300 outlining an example of using probability mass functions to enable object selection and object/material pairing, as can be performed in certain examples of the disclosed technology. In the illustrated example, different object categories are associated with different probabilities. As shown, the clothing category is associated with a normalized probability of 0.3 (or 30%). In the illustrated example, different probabilities can be assigned to more specific categories in the hierarchy. For example, different subcategories of the objects, for example fleece, shirt, or crew neck T-shirt are associated with different individual probabilities. Materials used in the object, for example cotton, nylon, and silk also each have an associated probability. By selecting specific object categories, subcategories, and/or materials, an individual object can be realized that will be placed within a container to be modeled.

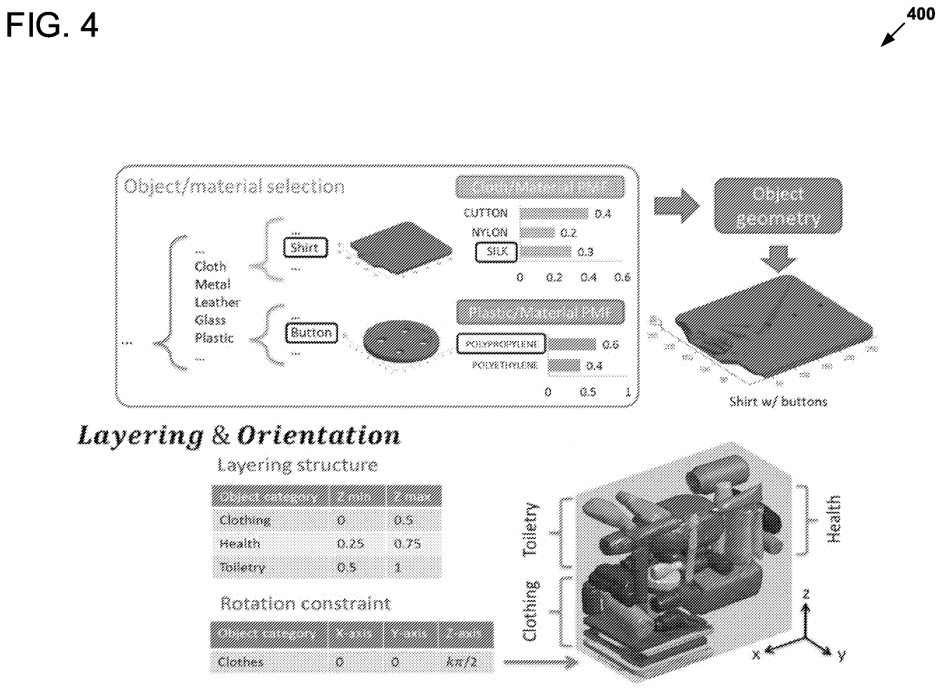

FIG. 4 is a diagram 400 outlining an example of applying layering and orientation constraints to place a plurality of objects within a container instance. As shown, items can be grouped in their placement within the instance based on the object category. For example, objects having the category clothing can be grouped together, while toiletry objects can be grouped in a different portion of the container instance.

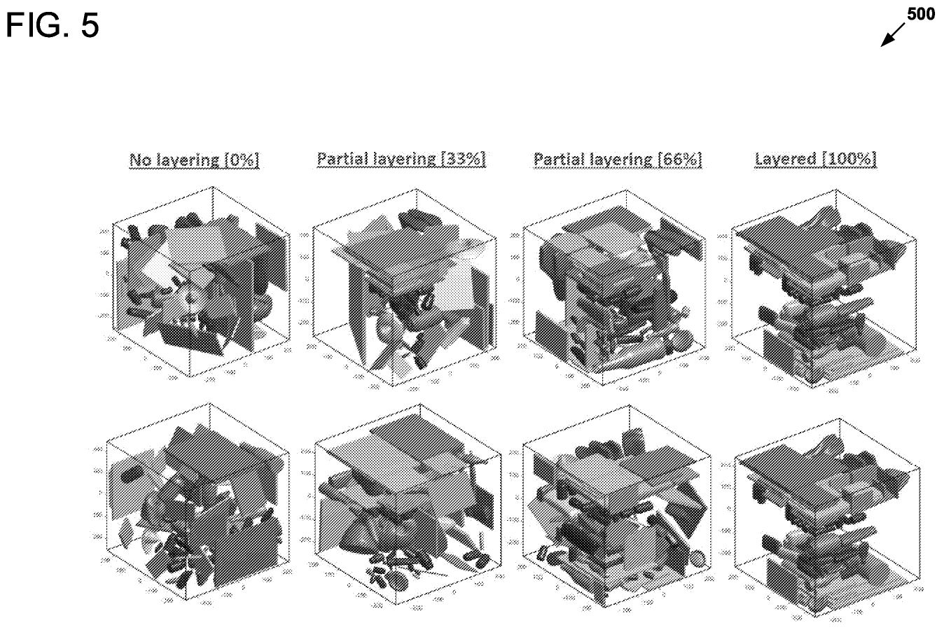

FIG. 5 is a diagram 500 depicting the effects of different amounts of layering on a resulting container instance. As shown, when there is no layering, objects are distributed randomly throughout the container. With increasing amounts of layering, the orientation and position of objects within the container more closely resembles that of real-world suitcases and other containers.

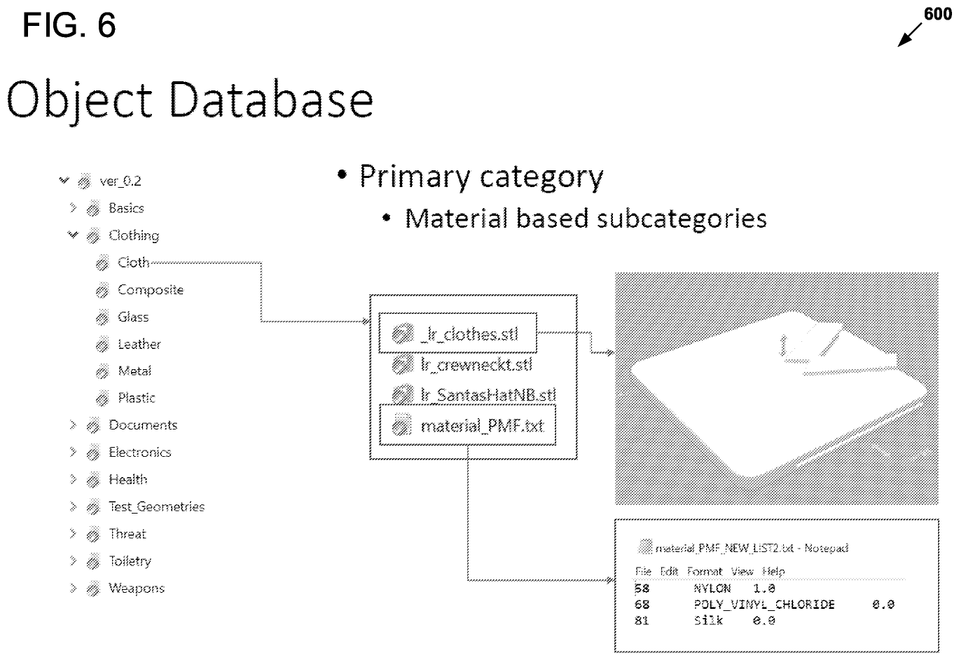

FIG. 6 is an illustration 600 of an example of an object database and in particular illustrates an entry for a shirt object in the database. The .stl (standard tessellation language) files are examples of a three-dimensional modeling file. In some examples, other formats can be used, for example, OBJ format, or JSON (JavaScript Object Notation) format. In particular, the depicted object is of the category clothing, and a number of different material categories are available, including nylon, PVC, and silk.

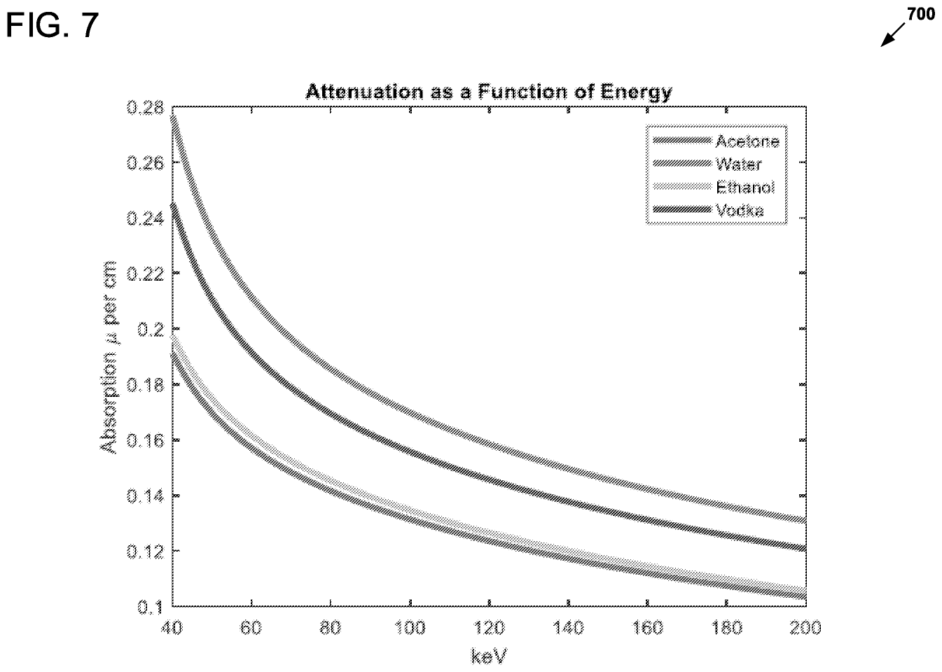

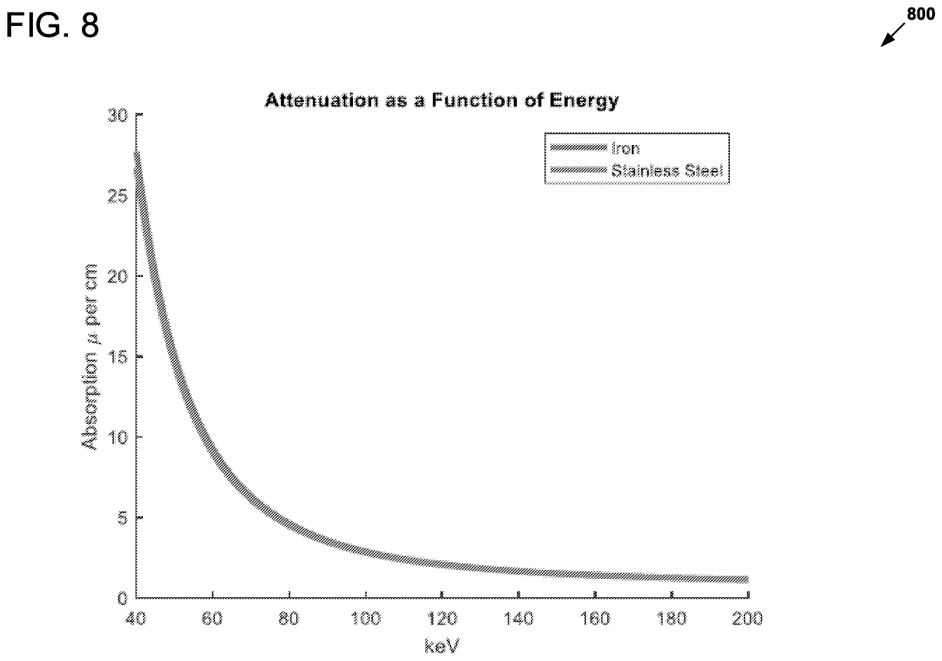

FIG. 7 is a chart 700 showing attenuation of X-ray radiation for different liquid materials. As shown, the absorption of radiation by the respective materials changes as a function of the X-ray energy exposed to the material. FIG. 8 is a chart 800 showing attenuation of X-ray radiation for different solid materials. As shown, the absorption of radiation by the respective solid materials changes as a function of the X-ray energy exposed to the material. The values shown in charts 700 and 800 are from the Department of Homeland Security DHS 13_05 material list. The material properties are independent of the bag generator.

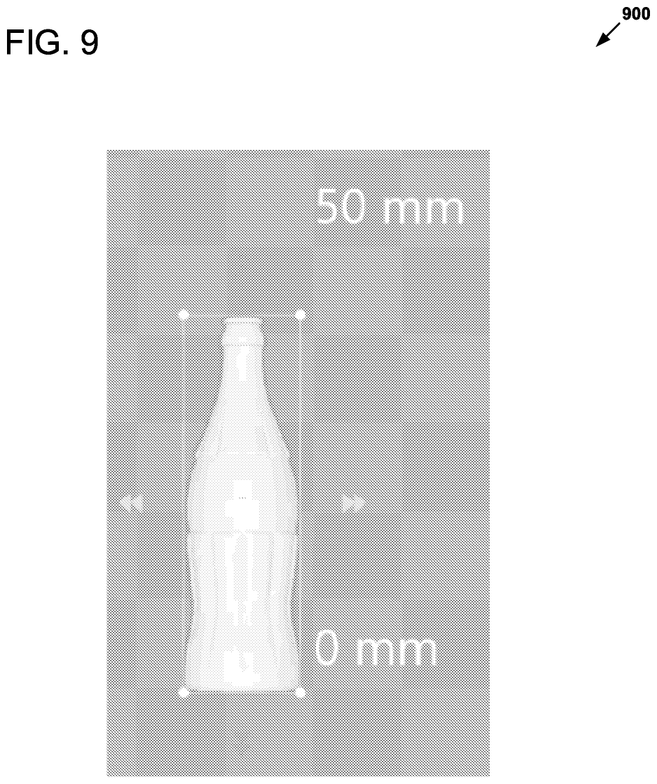

FIG. 9 is a diagram 900 illustrating an example object, in this case a beverage bottle that can be scaled. For example, a probability distribution function can be used to select a scale for the bottle, which is an instance created as an object having a particular size.

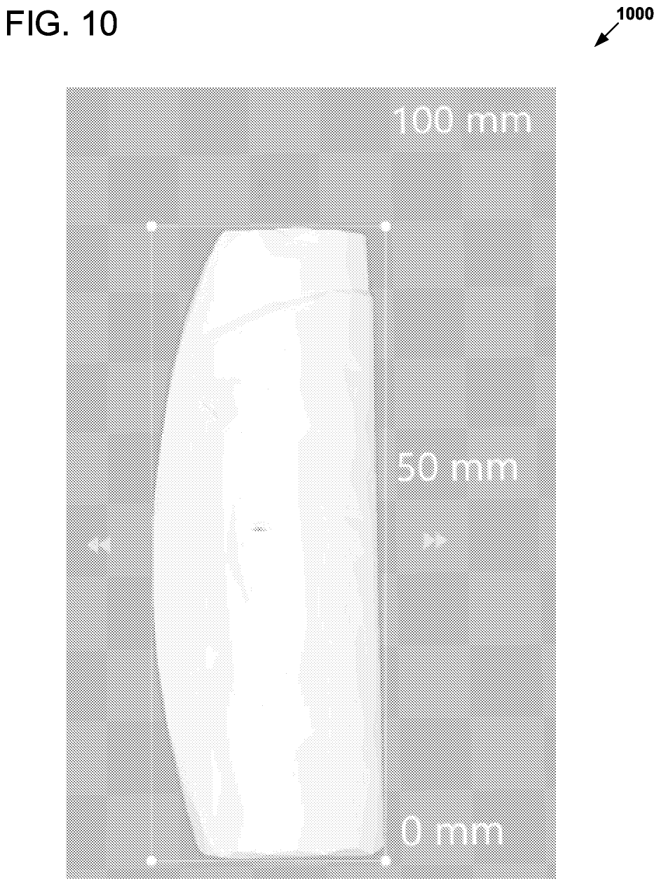

FIG. 10 as a diagram 1000 illustrating an example object, in this case a shampoo bottle that can also be scaled to create instances having particular sizes within a particular container. In some examples, objects have fixed dimension, and cannot be scaled.

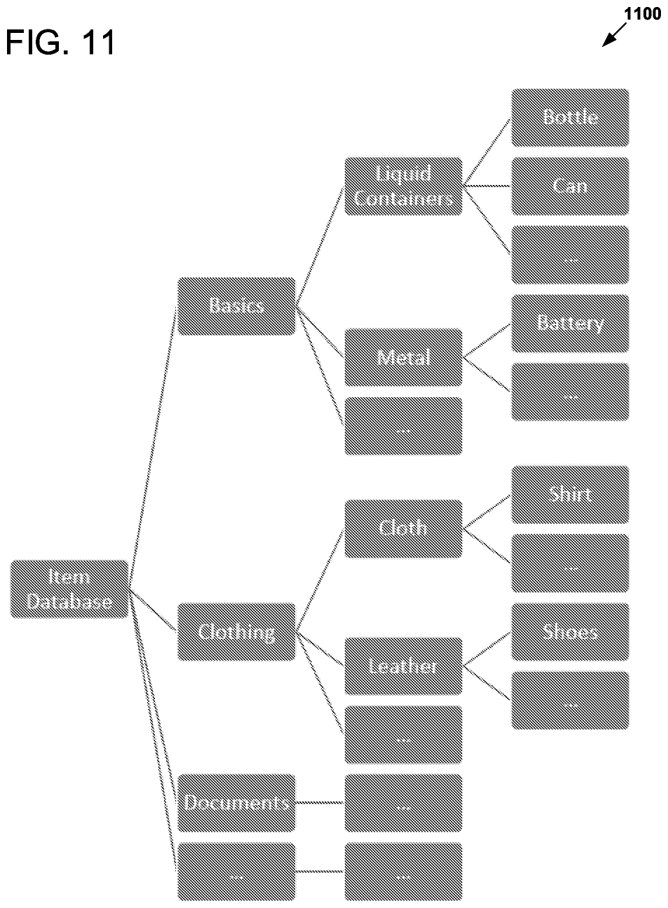

FIG. 11 is a diagram 1100 illustrating an example object hierarchy that can be provided in an object database. Different probabilities can be assigned to objects categories at each level of the hierarchy. For example, an object can be selected to be in either the basics category or the clothing category. Once a particular category has been selected, individual subcategories can be selected using separate probabilities, for example for metal versus liquid objects, and then particular categories of those objects selected at the next level of hierarchy.

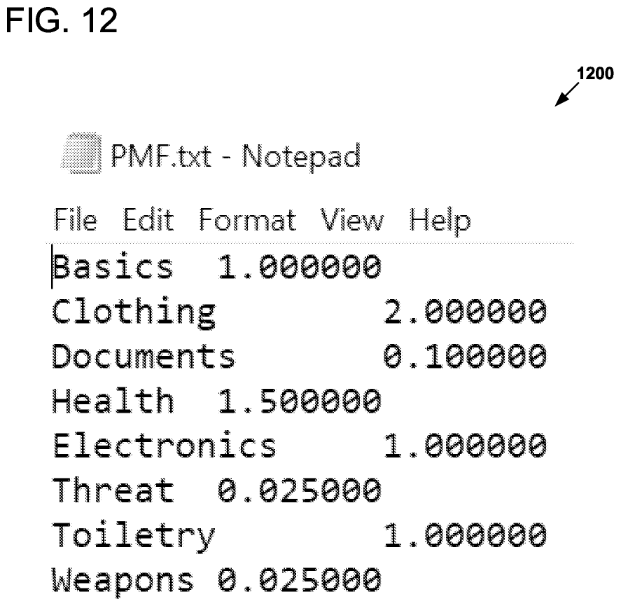

FIG. 12 is an example file 1200 including data for an unscaled probability mass function. The example probabilities can be used to select different categories of objects for placement within a container instance.

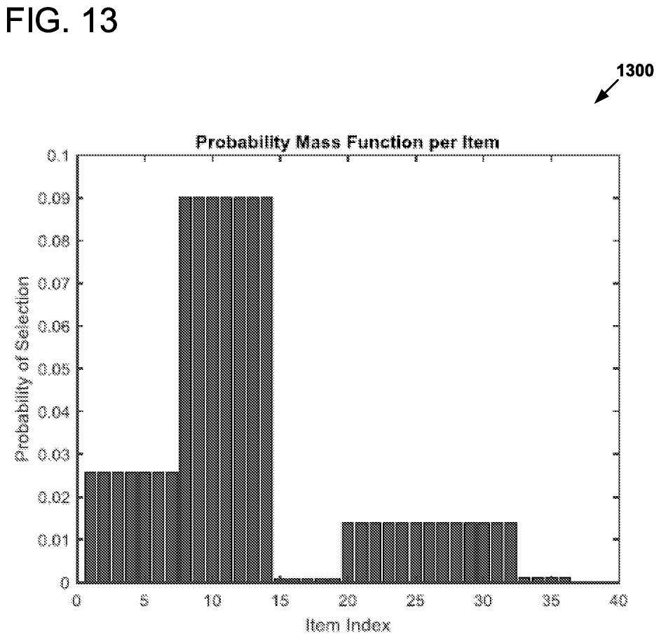

FIG. 13 is a chart 1300 illustrating probability mass functions assigned to different items in an object database, as can be implemented in certain examples of the disclosed technology. As shown, objects within the same subcategory have been assigned the same conditional probability. In other examples, different objects within the same category may be assigned different conditional probabilities.

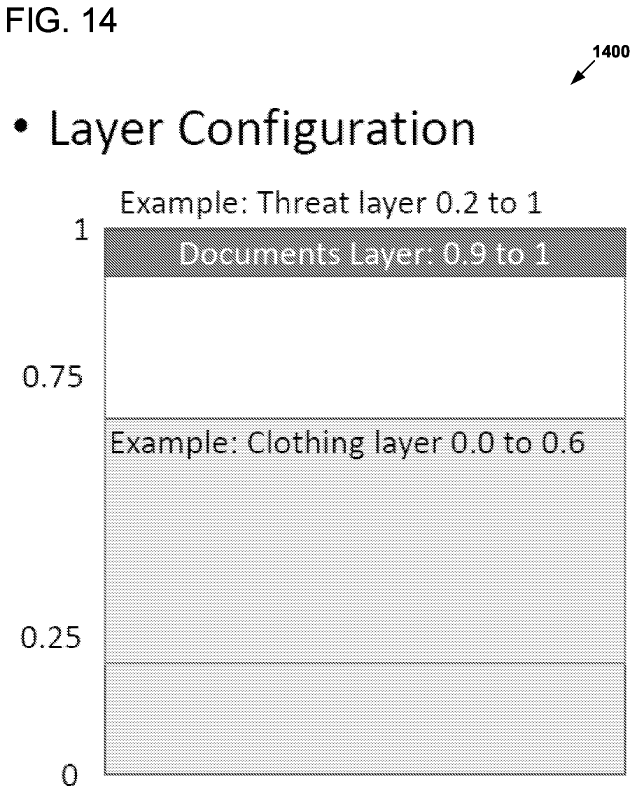

FIG. 14 is a chart 1400 depicting an example layer configuration as can be used in certain examples of the disclosed technology. As shown, objects of certain categories can be constrained to different layer levels within the container. Each category has a range of space within the bag and which objects of the category are permitted to be placed in. In the illustrated example, the range is expressed using a normalized min/max range going from 0.0 to 1.0. For example, clothing objects are most likely to be located in the lower portion, up to 0.6, of the container. Document objects are most likely to be located at the top portion, between 0.9 and 1.0. Threat objects can be located in a region that overlaps both the document object and the clothing object layers. As shown, layers for different categories can overlap, but objects belonging to a particular category are not permitted to be placed outside the layer for their respective category. However, if the range for an objects layer is set to range from 0.0 to 1.0, then that object can be placed anywhere within the container.

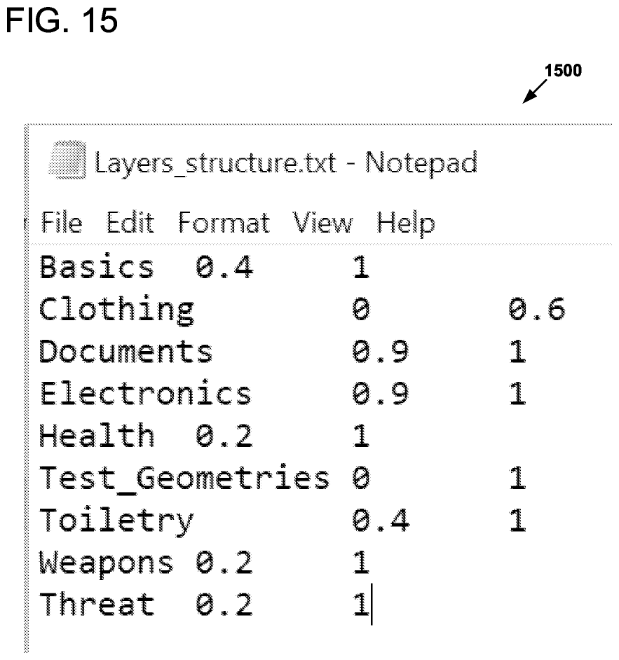

FIG. 15 depicts an example file 1500 storing data specifying layer regions for a container, as can be implemented in certain examples of the disclosed technology.

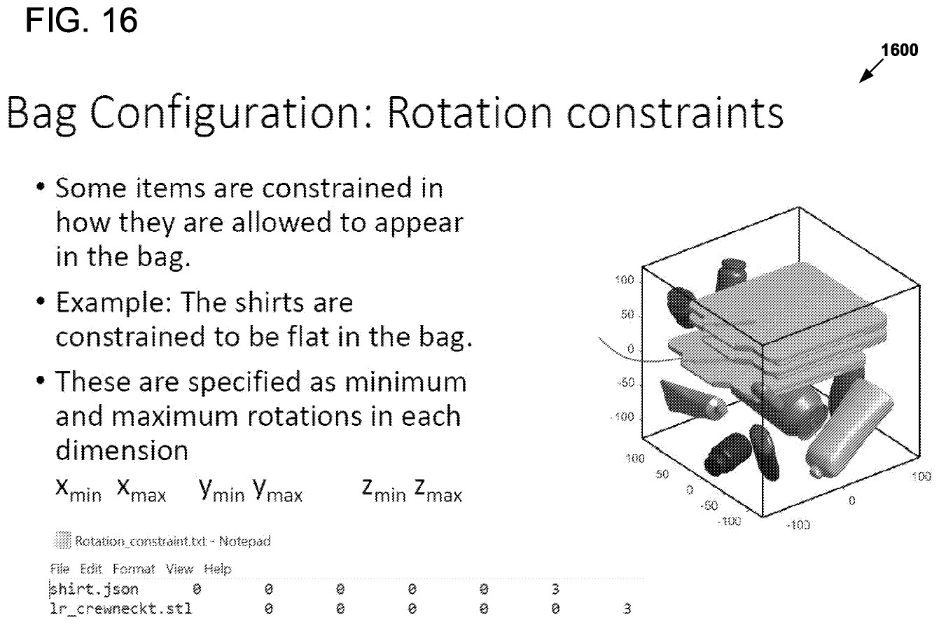

FIG. 16 is a diagram 1600 depicting use of rotation constraints within a container. For example, wide, flat objects are constrained to be relatively flat within the bag. Thus, items like shirts or pants are specified to have minimum and maximum rotations in each dimension. This reflects the likelihood that most people packing baggage will tend to layer such items substantially horizontal to the orientation of the bag/container.

### IV. Example Method of Generating Models

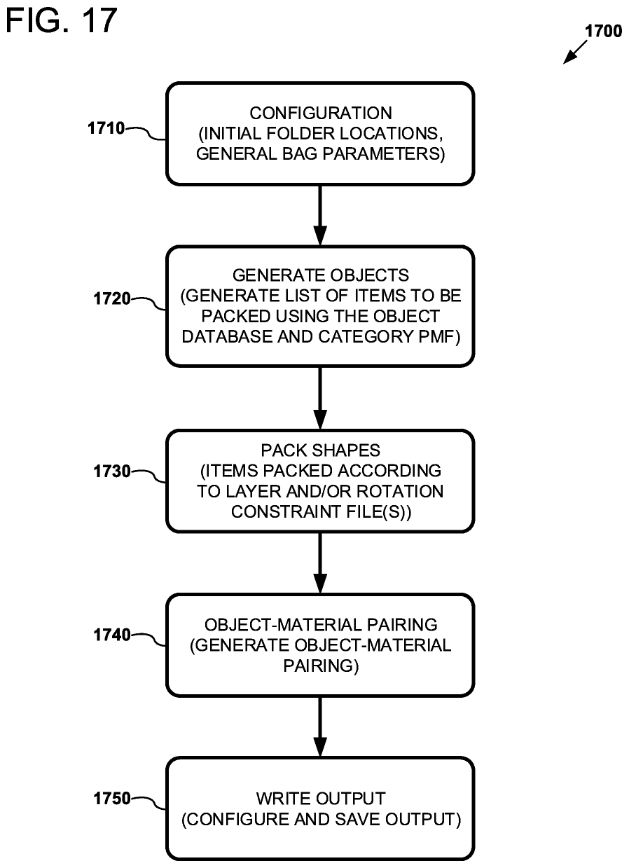

FIG. 17 is a flow chart 1700 outlining an example method of generating models for a container inspection system, as can be performed in certain examples of the disclosed technology. For example, computer systems disclosed herein can be used to generate container instances provided to explosive detection system simulators.

At process block 1710, a stochastic bag generator system is configured. For example, object to material databases, layer rules, scale rules, orientation rules, pairing roles, and other parameters used to generate instances can be configured by providing a database having different probabilities. In some examples, at least some of the probabilities can be randomly generated. In other examples, a user provides the probabilities. Configuration can include setting up a hierarchy of objects and materials as discussed further above. In some examples, a standard set of objects may be provided from a third party.

At process block 1720, a plurality of objects is generated. Different objects can be selected from the database that was configured at process block 1710. In some examples, a predetermined number of objects are selected, while in other examples, selected volume of objects may be selected.

At process block 1730, the objects or packed into a container. Position and orientation (e.g. rotation) of the objects are selected to be located within a container boundary. In some examples, some objects may have layer constraints and/or rotation constraints to more closely resemble how objects are packed in baggage in real life.

At process block 1740, pairings are generated for respective material for each of the objects, or sub objects in the case of compound/composite objects using a probability function. For example, a probability mass function, such that discussed above can be used to select materials to be paired with particular objects. The probability of materials associated with the particular object will vary based on the category of object. For example, shirt objects are more likely to be made from textile materials, while bottles are more likely to be made from metal, glass, or plastic.

At process block 1750, container instance is stored that includes data indicating different aspects of the generated instance. For example, object/material pairing information, object location, scale, orientation, object identifiers, or respective materials can be stored in a container instance data object that is stored in a computer readable storage medium or device.

### V. Exemplary Results and Computer Code

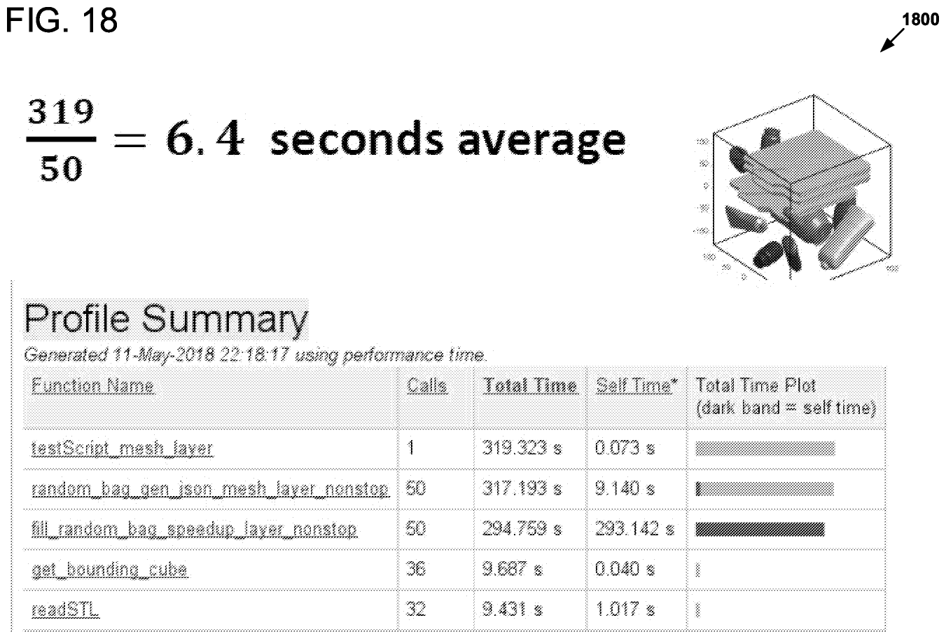

FIG. 18 is a table 1800 indicating a number of function calls and total time spent in different procedures when generating the illustrated container instance. In the illustrated example, an example program implemented according to the disclosed technology takes 319 seconds to generate 50 bags/containers with a volume of a 250 mm³.

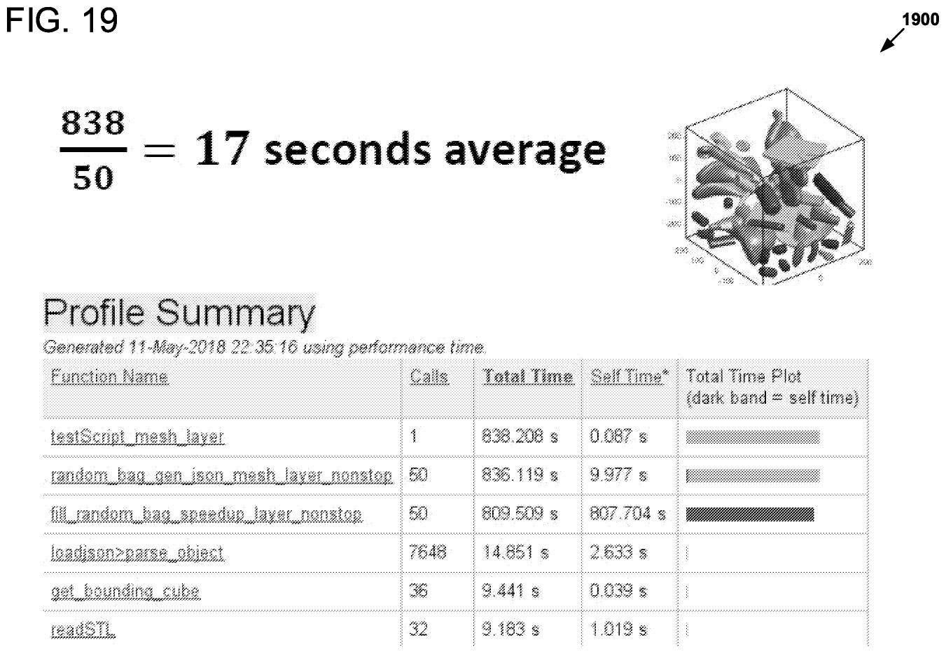

FIG. 19 is a table 1900 indicating a number of function calls and total time spent in different procedures when generating the illustrated container instance. In the illustrated example, the example program implemented according to the disclosed technology takes 838 seconds to generate 50 bags/containers each of with a volume of 500 mm³. Since the illustrated instance includes more objects and has a larger container than the one shown in FIG. 18, additional time is taken to generate the instance.

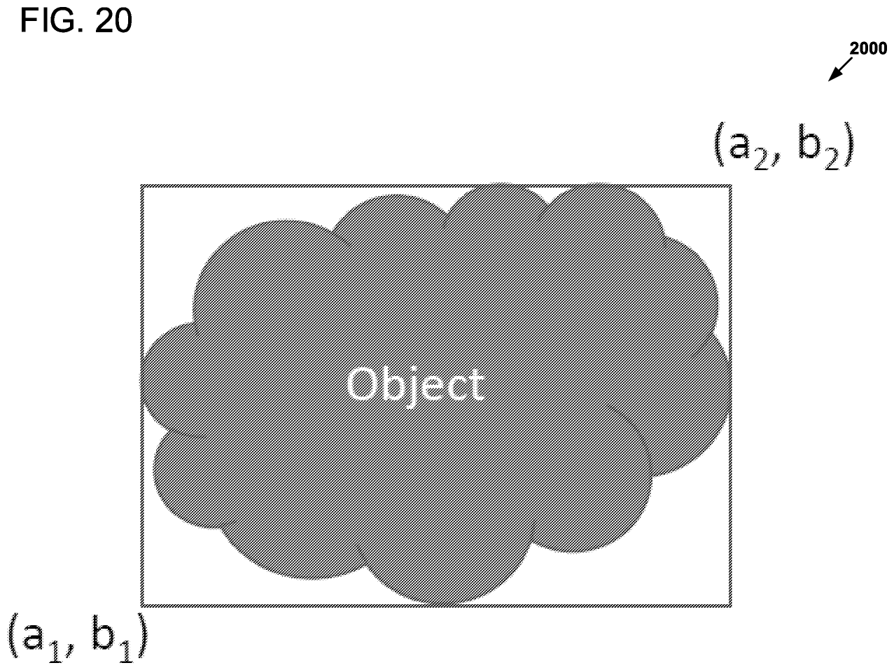

FIG. 20 is a diagram 2000 outlining minimum and maximum extent of an example object, as can be used in certain examples of the disclosed technology. Packing operations are based on illustrated bounding box described by the points (a₁, b₁) and (a₂, b₂). A three-dimensional object will have its bounding box described by two points have three dimensions. Unless otherwise specified, the term “bounding box” refers to a three-dimensional geometry enclosing the maximum extent of a particular object, instance, or collection of objects and/or instances.

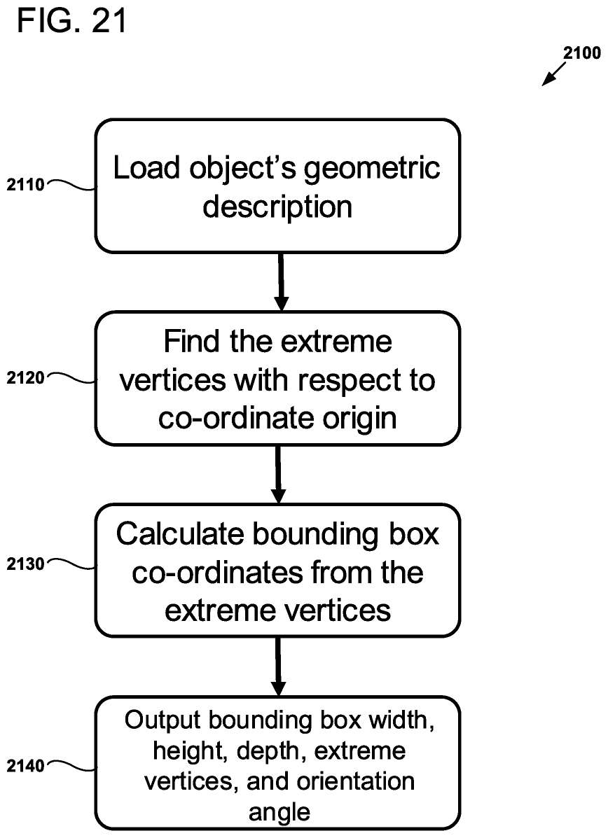

FIG. 21 is a flow chart 2100 outlining an example method of determining a bounding box for an object. The illustrated method can be performed using, for example, the computer system described above regarding FIG. 1.

At process block 2110, and objects geometric description is loaded. The geometric description of the object may be simple, or complex, including complex shapes, as well as multiple sub-objects. At process block 2120, the extreme vertices with respect to the coordinate origin are determined. For example, the highest x, y, z and lowest x, y, z values can be determined across all portions of a complex shape making up an object. At process block 2130, a bounding box is calculated from the coordinates of the extreme to vertices determined at process block 2120. At process block 2140, a bounding box's output including the bounding box with, height, depth, and extreme vertices, as well as an orientation angle for the object.

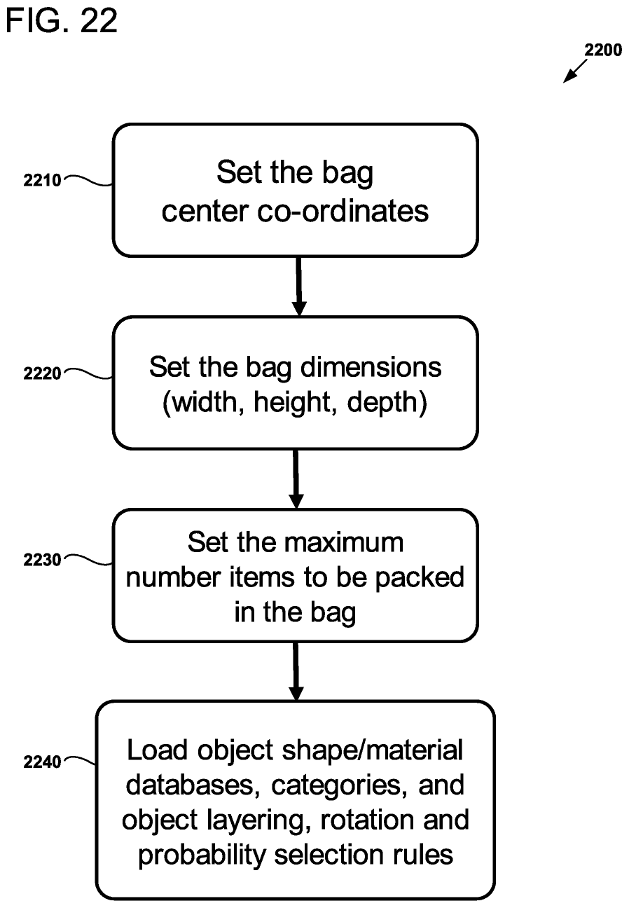

FIG. 22 is a flow chart 2200 outlining an example method of configuring a bag container, as can be performed in certain examples of the disclosed technology. The illustrated method can be performed using, for example the computer system described above regarding FIG. 1.

At process block 2210, the center coordinates of the container or bag are set. At process block 2220, dimensions of the bag, for example, width, height, and depth, are set. In some examples, the container is a cube. In other examples, the container can have other shapes, or have a more complex shape that a cube. At process block 2230, the maximum number of items to be packed in the container or bag is determined. For example, a randomly selected number of objects within a predetermined range can be selected. In other examples, the number of objects is based at least in part on the dimensions and/or size of the container. At process block 2240, data for objects to be packed in the container including data from object shape databases, object material databases, and object categories are selected. Rules for packing objects within the container, including rules describing object layering, object rotation, object scaling rules, and probability selection rules can also be loaded into a computer at process block 2240.

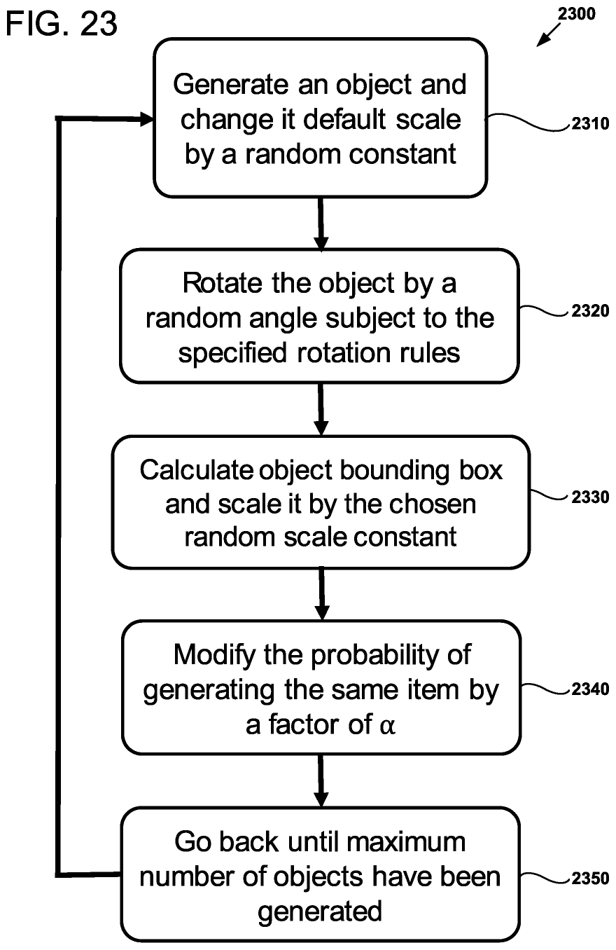

FIG. 23 is a flow chart 2300 outlining an example method of packing objects into a configured container, as can be performed in certain examples of the disclosed technology. The illustrated method can be performed using, for example, the computer system described above regarding FIG. 1.

At process block 2310, an object is generated based on data from object and material databases, as described above. The object can be changed from its default scale by applying a scaling function. In some examples, the scaling function applies a random constant selected from a range specified as a part of bag packing rules.

At process block 2320, the object is rotated. For example, the object can be rotated to a random angle. In some examples, the object is rotated to a random angle, subject to rotation rules that are specified for the object and/or the container.

At process block 2330, a bounding box for the object is calculated. The objects bounding box can be scaled by a selected random scale constant.

At process block 2340, the probability of generating the same object is modified by a factor of α. In other examples, more complex probability factors or rules can be used. In some examples, each object is associated with its own probability factor that adjusts the likelihood that the object will be selected as additional instances of a particular category of object are selected. For example, certain objects, such as toothpaste tubes or shampoo bottles may be likely to be found within the container, but are typically only found and quantities of one or two. Other objects, for example garments such as shirts, pants, or socks, may be more likely to be found in greater quantities.

At process block 2350, the method proceeds back to process block 2310, until a stopping condition is met. For example, the method may iterate back to process block 2310 until a maximum number of objects has been generated. In other examples, the method may iterate until a different limit is met, for example, total volume of objects placed within the container, or the amount of space consumed by objects according to their actual placements within the container.

Thus, the methods illustrated above regarding FIGS. 20-23 can be used to perform a number of operations associated with packing objects in a container, including configuring container/bag settings, including container size and origin, a maximum number of items to be placed in the container, descriptions of probability mass functions, scale functions, and rotation, and identification of object and material databases. The generated objects can be used to populate an object list, including with simple and compound objects. The computer can also be configured to calculate or load bounding cubes of container. Data used to describe objects can be stored in a hierarchical data structure. In some examples, simpler objects can be described in .stl files, while compound objects are described in JSON files. In some examples, all objects in a system are described in a single file format.

Probability mass functions for selecting and positioning objects can be based on categories of items. In other examples, different schemes for assigning probability mass functions may be used.

A computer configured to perform the illustrated can load rotation constraints and object scaling parameters from a database. Items are selected to pack, and the selected items and layer parameters are passed to a packing routine. An item selection process including a dampening factor, α. after each item selection, the probability of selecting that item is reduced by a factor of α. For example, the following formulation can be used to adjust probability when selecting items:

$$P ( i t e {m}_{a fter} ) = \frac{P ( i t e {m}_{b efore} )}{∝}$$

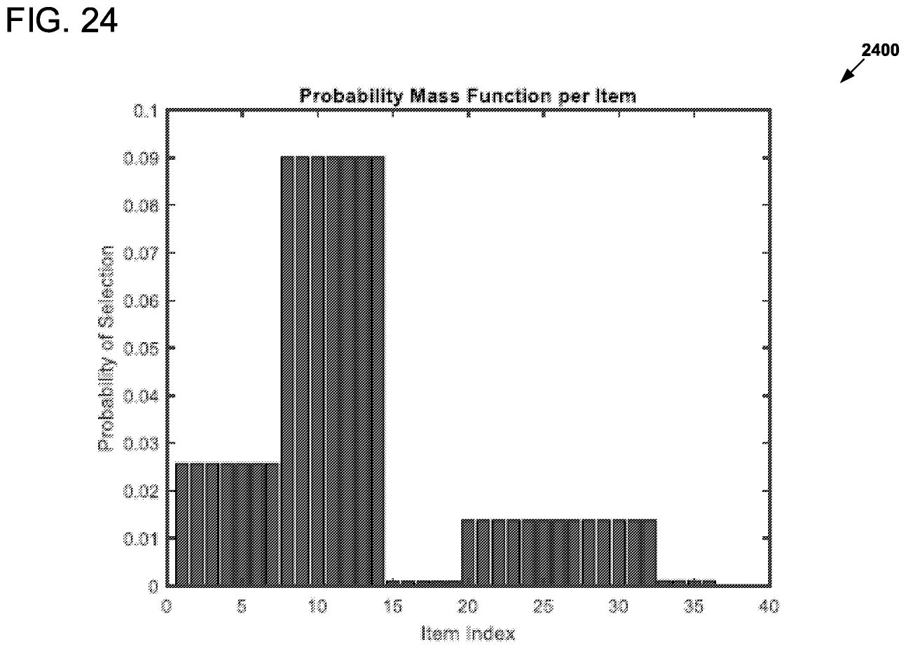

FIG. 24 is a chart 2400 depicting probability mass functions for a number of items in an object database, as can be implemented in certain examples of the disclosed technology. As shown, no items have yet been selected for placing within a container instance. Thus, the object probabilities for all objects within a category are the same.

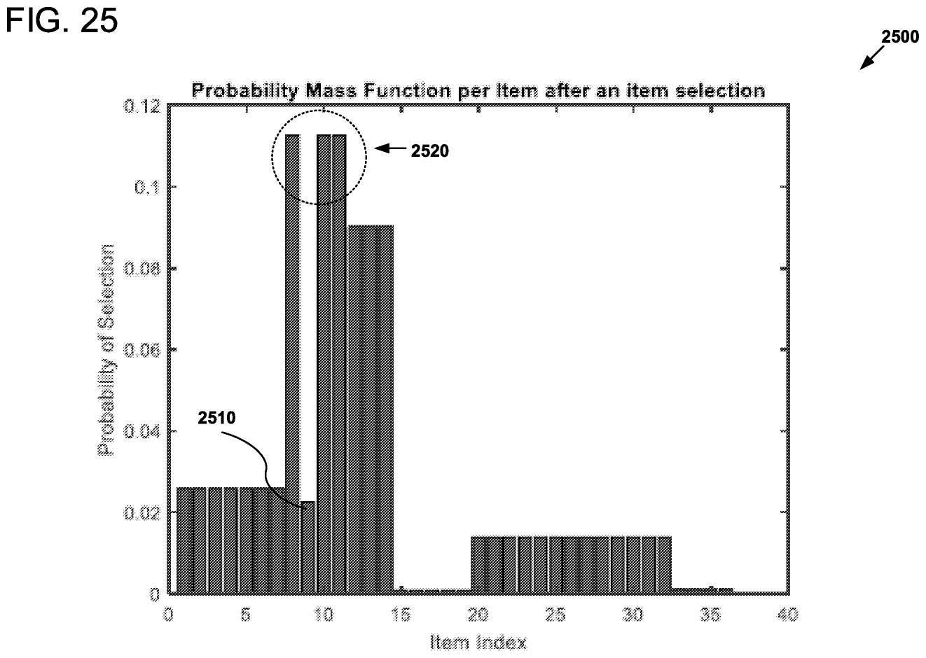

FIG. 25 is a chart 2500 depicting probability mass functions for items in the database after an object has been selected to add to the container instance. As shown, the probability mass function changes for each item depending on the category of object that was selected. The conditional probability for the selected object is reduced 2510, while the object probability for unselected objects is increased 2520 as shown.

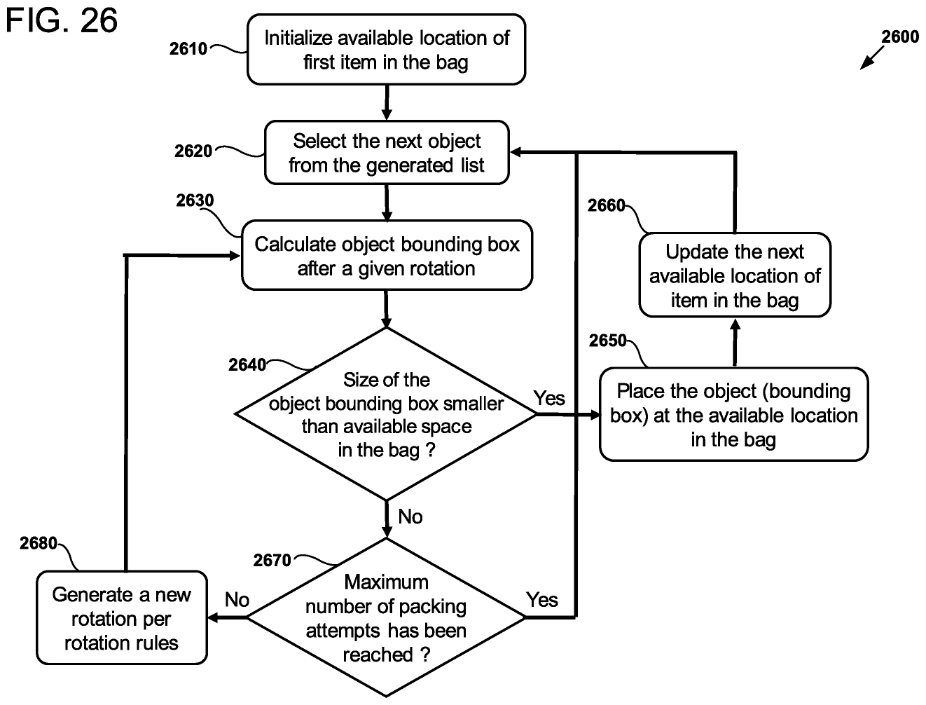

FIG. 26 is a flow chart 2600 outlining an example method of placing objects in a container, as can be performed in certain examples of the disclosed technology. The illustrated method can be performed using, for example, the computer system described above regarding FIG. 1. The illustrated method causes a computer to iterate object placements and rotations to see if items will fit within the container. As discussed further below, a maximum number of trials and rotations for an attempted packing of an object is set. The loop will iterate until it runs out of object to place or a maximum number of trials is exceeded. Objects that are successfully packed have their respective orientation properties added to an output data structure that includes the objects rotation, scale, center point (an origin), bounding box, and/or item index.

At process block 2610, a location of a first object to be placed in the container is initialized. At process block 2620, a next object from a list of generated objects is selected. In some examples, the list can be ordered by attributes of the objects, including by way of example, size, shape, frequency, an additional attribute, or other suitable method. In other examples, different data structures are used to store a number of objects to be placed within the container.

At process block 2630, a bounding box for an object is calculated for a given rotation. For example, an initial rotation can be selected, and if placement of the object within the container is unsuccessful, a different orientation or position can be selected.

At process block 2640, the method determines whether the size of the object's bounding box is smaller than available space within the container. If the size of the bounding box is smaller, then the method proceeds to process block 2650, and the object is placed at an available location within the container. For example, the object can be placed by placing only its bounding box. In other examples, the object itself is placed within the container. At process block 2660, a next available location for items within the container is determined, and the method proceeds to process block 2620.

At process block 2670, the method determines whether a maximum number of packing attempts has been reached. If the number of packing attempts does not exceed the maximum number, the method proceeds to process block 2680. At process block 2680, a new rotation is generated per rotation rules for the selected object. The method then proceeds to process block 2630 in order to calculate the objects bounding box given its new rotation. If the number of packing attempts does exceed the maximum number, then the method proceeds to process block 2620, in order to select a next object to attempt placement within the container from the generated list.

A description of the placed objects and container can be output into any suitable file format, for example, a JSON file. This description can include output describing a bounding region of the inner bag and outer bag, position of objects within the container, rotation, and scale of objects within the container, material properties of the objects, and children within the hierarchy for the object. For composite objects, a unique identifier can be generated along with the object's placement coordinates, scale, materials, associated object models, and identifiers of child objects of the composite object.

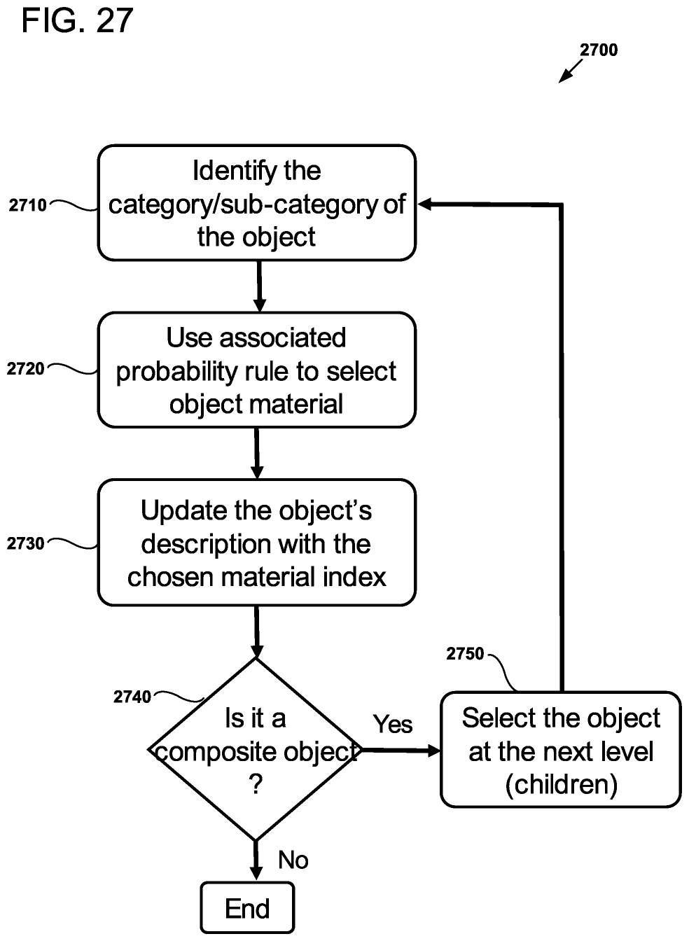

FIG. 27 is a flow chart 2700 outlining an example method of selecting materials for an object, as can be performed in certain examples of the disclosed technology. The illustrated method can be performed using, for example, the computer system described above regarding FIG. 1.

At process block 2710, a category, and in some examples a sub-category of an object is identified. For example, an object database can be arranged according to a hierarchy. An example of a category might be garments, and a subcategory might be shirts, pants, or skirts.

At process block 2720, a probability rule associated with an object and/or the objects category and/or sub-category is used to select an objects material. Thus, a material can be selected with a given probability for each different category of object.

At process block 2730, the object's description is updated with the chosen material index.

At process block 2740, the method determines whether the object is a composite object. If the object is not a composite object, then the operations of selecting materials can end for the given instance of the object. If the object is a composite object, the method proceeds to process block 2750 in order select objects at the next level of the object. For example, a composite object representing a pair of shoes might have lower-level objects to represent the shoes upper, sole, and laces.

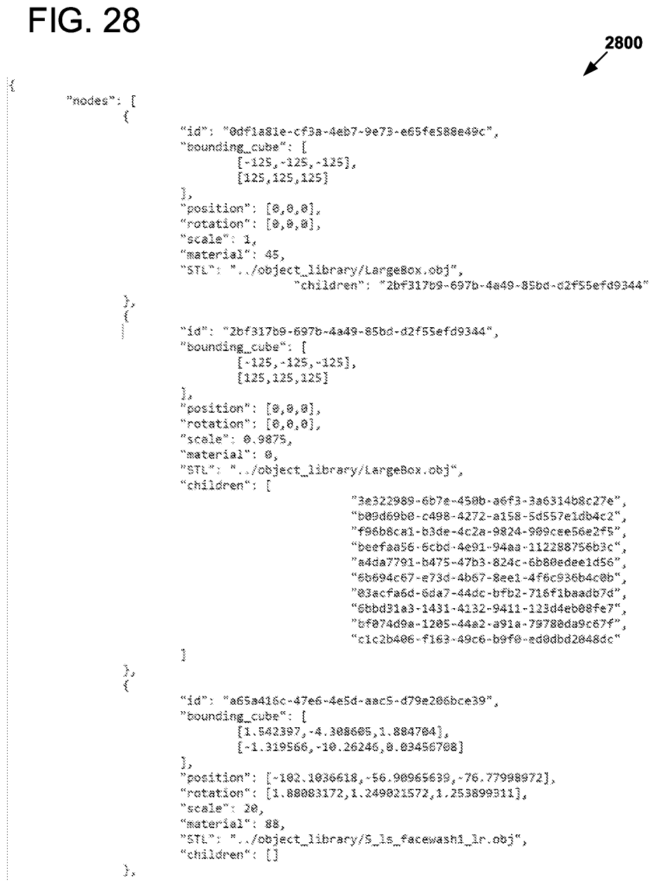

FIG. 28 is an example of a JSON data file 2800 storing a portion of objects and a container instance. As shown, an object includes a unique item identifier, a bounding cube expressed as opposing corner coordinates of a cube, a position vector, a rotation vector, a scalar scale, a material identifier associated with the object, a description of a 3D model describing the surface of the object, and a list of identifiers of children objects for the composite object.

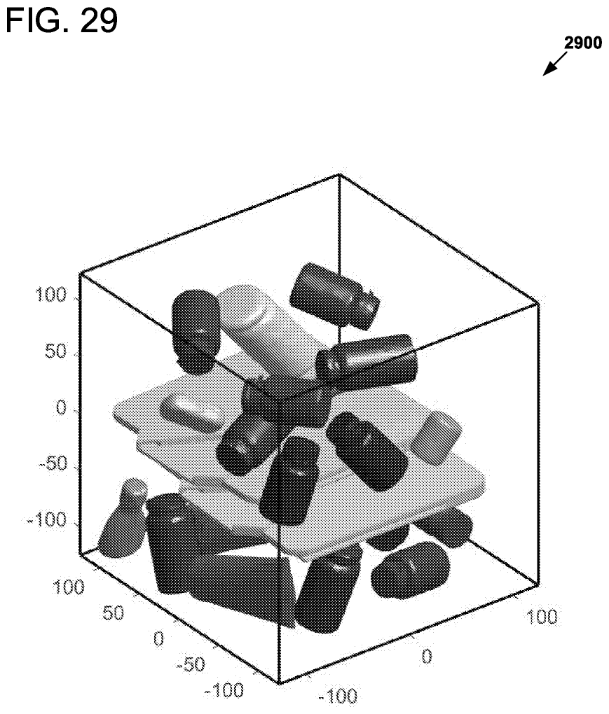

FIG. 29 is a diagram 2900 illustrates an example container instance having a number of different objects within the container region, as can be generated using example methods disclosed herein.

### VI. Example Method of Generating Container Models

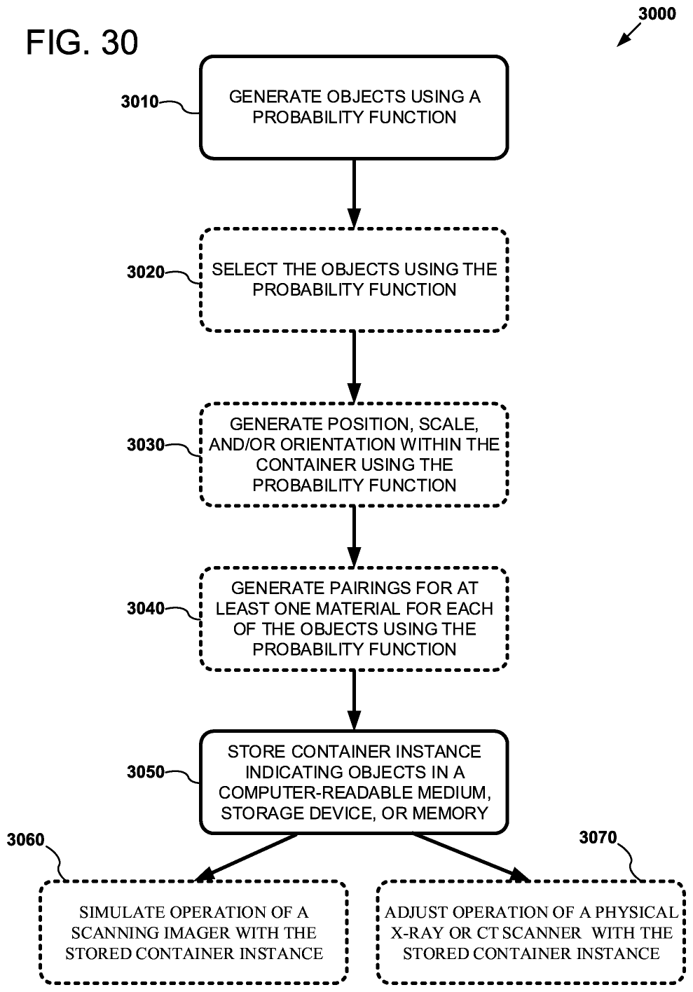

FIG. 30 is a flow chart 3000 outlining an example method of generating container models for a container inspection system, as can be performed in certain examples of the disclosed technology. Any of the apparatus and computer-readable media described herein can be used to implement the illustrated method. Further, any suitable method described herein can be combined with one or more aspects of the illustrated method.

At process block 3010, one or more objects are generated using a probability function. Some examples, the probability function is a probability mass function. At least one of the following process blocks 3020, 3030, and/or 3040 are used to generate the objects using the probability function; but two of these process blocks may be omitted in some examples. In some examples, only one of these three process blocks is used. In other examples to or all of the illustrated three process blocks can be used as part of generating objects at process block 3010. When one or more of the three process blocks are omitted, the associated selection of objects, generation of position, scale, and orientation, or generating pairings of materials with objects can be from performed using a different technique, for example using a deterministic method, or receiving an input from an external source.

At process block 3020, objects are selected using a probability function. For example, a library or database of objects can be provided, and objects selected to be placed in the container using the probability function. In this way, certain types of objects can be selected more frequently than others based on the probability function. In some examples, the probability function is a probability mass function.

At process block 3030, at least one of position, scale, and/or orientation of the objects within the container is determined using a probability function. In some examples, only one of these attributes is determined using the probability function, while in other examples, two or more of the attributes are determined using the probability function. In this way, certain positions, scales, or orientations of objects can be selected with more frequency than other objects, for example shirts or pants placed in the container are more likely to be stacked than other types of objects in a luggage container. In some examples, the probability function is a probability mass function.

At process block 3040, pairings are generated for at least one material for the objects using a probability function. In some examples, each object is associated with a single material, while in other examples, multiple materials may be selected for a single object. In some examples, a compound object may include multiple objects each having an associated material. In this way, certain materials can be selected with more frequency than other materials, based on the probability function. In some examples, the probability function is a probability mass function.

At process block 3050, a container instance is stored indicating the generated objects in a computer readable medium, storage device, and/or memory. Any suitable computer readable storage can be used. The container instance can be provided for use at optional process blocks 3060 and/or 3070.

At process block 3060, operation of a scanner image is simulated with the stored container instance from process block 3050. Example, an X-ray simulator can be used to simulate scattering of X-rays through the container, in order to simulate the operation of a scanner.

At process block 3070, operation of a physical scanner, such as an X-ray, CT, or milliwave scanner can be adjusted using the stored container instance. For example, one or more operational parameters of a physical scanner can be selected or adjusted based on one or more container instances generated at process block 3050.

### VII. Example Computing Environment

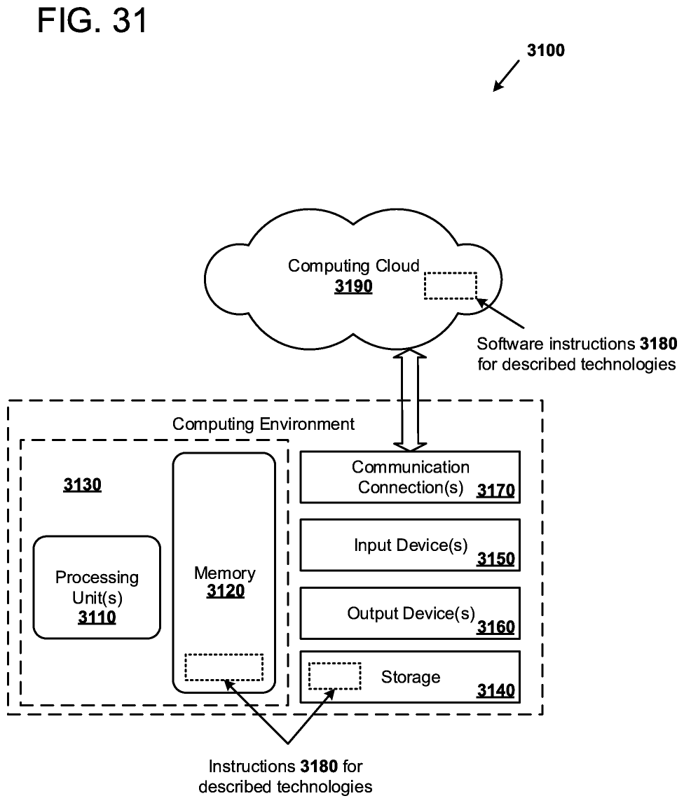

FIG. 31 illustrates a generalized example of a suitable computing environment 3100 in which described embodiments, techniques, and technologies can be implemented. For example, the computing environment 3100 can implement any of the stochastic bag generators or scanning system simulators, as described herein.

The computing environment 3100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 31, the computing environment 3100 includes at least one central processing unit 3110 and memory 3120. In FIG. 31, this most basic configuration 3130 is included within a dashed line. The central processing unit 3110 executes computer-executable instructions and may be a real or a virtual processor. In a multi-processing system, multiple processing units execute computer-executable instructions to increase processing power and as such, multiple processors can be running simultaneously. The memory 3120 may be volatile memory (e.g., registers, cache, RAM), non-volatile memory (e.g., ROM, EEPROM, flash memory, etc.), or some combination of the two. The memory 3120 stores software 3180, images, and video that can, for example, implement the technologies described herein. A computing environment may have additional features. For example, the computing environment 3100 includes storage 3140, one or more input devices 3150, one or more output devices 3160, and one or more communication connections 3170. An interconnection mechanism (not shown) such as a bus, a controller, or a network, interconnects the components of the computing environment 3100. Typically, operating system software (not shown) provides an operating environment for other software executing in the computing environment 3100, and coordinates activities of the components of the computing environment 3100.

The storage 3140 may be removable or non-removable, and includes magnetic disks, magnetic tapes or cassettes, CD-ROMs, CD-RWs, DVDs, or any other medium which can be used to store information and that can be accessed within the computing environment 3100. The storage 3140 stores instructions for the software 3180, plugin data, and messages, which can be used to implement technologies described herein.

The input device(s) 3150 may be a touch input device, such as a keyboard, keypad, mouse, touch screen display, pen, or trackball, a voice input device, a scanning device, or another device, that provides input to the computing environment 3100. For audio, the input device(s) 3150 may be a sound card or similar device that accepts audio input in analog or digital form, or a CD-ROM reader that provides audio samples to the computing environment 3100. The output device(s) 3160 may be a display, printer, speaker, CD-writer, or another device that provides output from the computing environment 3100.

The communication connection(s) 3170 enable communication over a communication medium (e.g., a connecting network) to another computing entity. The communication medium conveys information such as computer-executable instructions, compressed graphics information, video, or other data in a modulated data signal. The communication connection(s) 3170 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and destination agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 3190. For example, agents can be executing vulnerability scanning functions in the computing environment while agent platform (e.g., bridge) and destination agent data consumer service can be performed on servers located in the computing cloud 3190.

Computer-readable media are any available media that can be accessed within a computing environment 3100. By way of example, and not limitation, with the computing environment 3100, computer-readable media include memory 3120 and/or storage 3140. As should be readily understood, the term computer-readable storage media includes the media for data storage such as memory 3120 and storage 3140, and not transmission media such as modulated data signals.

In view of the many possible embodiments to which the principles of the disclosed technology may be applied, it should be recognized that the illustrated embodiments are only preferred examples and should not be taken as limiting the scope of the claims. Rather, the scope of the claimed subject matter is defined by the following claims. We therefore claim as our invention all that comes within the scope of these claims.

1. A computer-implemented method of generating container models for a container inspection system, the method comprising:
generating objects using a probability function; and
storing a container instance indicating the objects in a computer-readable medium, storage device, or memory.

2. The method of claim 1, wherein the generating the objects comprises selecting the objects using the probability function.

3. The method of claim 1, wherein the generating the objects comprises generating a respective position, scale, and orientation for each of the objects within a container having a defined boundary using the probability function.

4. The method of claim 1, wherein the generating the objects comprises generating pairings for at least one respective material for each of the objects using the probability function.

5. The method of claim 1, wherein the probability function is a probability mass function including a conditional probability for each level of a hierarchy of categories for the object.

6. (canceled)

7. The method of claim 5, wherein:
the probability mass function includes a value representing a probability that an object is in a selected category of a plurality of categories;
the probability mass function includes a value representing a probability that an object has a particular shape; or
the probability mass function includes a value representing a probability that the respective object comprises a particular category of material.

8-9. (canceled)

10. The method of claim 1, wherein the probability function is a first probability function, and wherein the generating the objects comprises at least one of the following:
selecting the objects using the first or a second probability function;
generating a respective position, scale, and orientation for each of the objects within a container having a defined boundary using the first or a third probability function;
generating pairings for at least one respective material for each of the objects using the first or a fourth probability function; and
wherein at least one of the second, third, or fourth probability functions is the same as the first probability functions.

11. The method of claim 10, wherein at least one of the first, second, third, or fourth probability functions is a probability mass function.

12. The method of claim 1, wherein the stored container instance indicates at least one of: generated pairings, positions of the objects, object scales, object orientation, the objects, or materials of the respective objects in a computer-readable medium, storage device, or memory.

13. The method of claim 1, further comprising at least one of the following:
simulating operation of a scanning imager with the stored container instance;
modeling physical deformation of at least one of the objects within the container; or
selecting at least one of the objects to have a category of threat, contraband, or weapon.

14-15. (canceled)

16. The method of claim 1, wherein:
the generating a respective position comprises using a probability mass function representing two or more layers or regions within the container;
the generating a respective position comprises selecting an orientation for each of the objects, at least one of the objects having an orientation constraint;
the plurality of categories comprises at least one of: basics, clothing, documents, electronics, health, threats, toiletries, or weapon;
at least one of the plurality of objects has dimensions defined by scaling a parameterized version of the at least one object;
at least one of the plurality of objects has dimensions defined by scaling a parameterized version of the at least one object; and
at least one of the objects is a composite object comprising two or more shapes and/or two or more materials.

17-20. (canceled)

21. One or more computer-readable storage media storing computer-executable instructions that when executed, caused the computer to perform a method of generating container models for a container inspection system, the instruction comprising:
instructions that cause the computer to produce objects using a first probability function;
instructions that cause the computer to select the objects using the first or a second probability function;
instructions that cause the computer to generate a respective position, scale, and orientation for each of the objects within a container having a defined boundary using the first or a third probability function;
instructions that cause the computer to generate pairings for at least one respective material for each of the objects using the first or a fourth probability function; and
instructions that cause the computer to produce a container instance indicating the objects in a computer-readable medium, storage device, or memory;
wherein at least one of the second, third, or fourth probability functions is the same as the first probability functions.

22. (canceled)

23. An apparatus comprising:
memory; and
at least one processor configured to implement a stochastic bag generator and an interface to at least one database comprising an input object database, an input material database, and an input configuration database.

24. The apparatus of claim 23, further comprising:
an interface to a system model simulator; or
an interface to an image scanner.

25. (canceled)

26. The apparatus of claim 25, wherein the image scanner is an X-ray scanner or CT scanner.

27. The apparatus of claim 23, wherein the stochastic bag generator is configured to:
generate a plurality of objects using a probability function;
generate a respective position, scale, and orientation for each of the objects within a container having a defined boundary;
generate pairings for a respective material for each of the objects using a probability function; and
store a container instance indicating at least one of: the generated pairings, the respective object positions, object scales, object orientation, the objects, or the respective materials in a computer-readable storage device.

28. The apparatus of claim 27, further comprising a system model simulator, the simulator being configured to perform a stochastic or deterministic simulation of electromagnetic spectra in an environment including the container instance.

29. (canceled)

30. The method of claim 1, further comprising:
simulating a scanner image with the container instance;
adjusting or selecting operational parameters of a physical scanner of the container inspection system; and
operating the physical scanner having the adjusted or selected operational parameters to scan at least one physical object.

31. The computer-readable storage media of claim 21, wherein the instructions further comprise:
instructions that cause the computer to simulate operation of a container inspection system scanner.

32. The computer-readable storage media of claim 21, wherein the instructions further comprise:
instructions that cause the computer to adjust operation of a container inspection system scanner by selecting one or more operational parameters of the scanner.
